(19) United States
(12) Patent Application Publication
(10) Pub. No.: US 2009/0213842 A1
(43) Pub. Date: Aug. 27, 2009

(54) COMMUNICATION LINK ESTABLISHING METHOD

(76) Inventors: Jen-Ya Huang, Taipei City (TW); Ten-Long Dan, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/370,547

(22) Filed: Feb. 12, 2009

(30) Foreign Application Priority Data
Feb. 26, 2008 (TW) 097106609

(51) Int. Cl. H04L 12/66

(52) U.S. Cl. 370/352

(57) ABSTRACT

When a communication device receives a request of connection, the communication device selects a destination address from multiple destination addresses according to data provided by a server. After a destination address is selected from the multiple destination addresses, the communication device connects a source address and the selected destination address.

### BACKGROUND OF THE INVENTION

1. Field of the Invention

The invention relates to a communication link establishing method and, more particularly, to a method which can establish a communication link by a data provided by a server.

2. Description of the Related Art

With jump improvement of the communication age, from past telephones to mobile phones or VoIPs, development of communication devices and technology becomes more and more inseparable from modern human lives. The communication field, the computer field, and the network field are growing from independent respectively to integrated, and a lot of cross-field operation is possible, such as making a VoIP call by common communication devices, or receiving or sending an email by the mobile phones.

During daily life, the communication devices seen as contacting tools by modern people are used frequently, therefore, each communication company is competing for providing various premium unit price schemes to users, and further for the huge consumer market. However, updated speed of the unit price schemes provided by each communication company is so quick and the kinds of the unit price schemes is so numerous that consumers are unable to distinguish clearly and make a call which is the most suitable and the most economic. For example, the consumer has a number 0968 xxxxxx (communication address) and a number 0988xxxxxx (communication address), and a friend he/she wants to contact has a number 0953xxxxxx and a number 0914xxxxxx (communication address). The consumer is to select the most economic dialing way, however, there are various premium unit price schemes, and in a period of time, the consumer cannot query one by one which is cheaper either to dial 0953xxxxxx by 0988xxxxxx or dial 0914xxxxxx by 0968xxxxxx. Thus, the consumer cannot select a dialing way and will waste a lot of money.

### SUMMARY OF THE INVENTION

The invention provides a communication link establishing method. The method includes the steps of: when the communication device receiving a request of connection, comparing at least a source address and at least a destination address according to the data provided by a server; selecting an appropriate destination address according to comparing result of the communication links between the source address and the destination address; and establishing the communication link according to the appropriate destination address.

The invention also provides a communication link establishing method. The method includes the steps of: when the communication device receiving a request of connection, comparing, at least a source address and at least a destination address according to data provided by a server; displaying at least a comparing table of the communication links according to comparison of the communication links between the source address and the destination address; selecting an appropriate destination address according to the comparing table; and establishing the communication link according to the appropriate destination address.

The invention provides, before a user wants to establish a communication link, comparison of communication links between every source address and every destination address to connect, which makes the user be able to select the most economic and communication link to solve the above problems.

### BRIEF DESCRIPTION OF THE DRAWINGS

FIG. 1 is a diagram showing a communication network according to one embodiment of the invention.

FIG. 2 is a flow chart showing a communication link establishing method according to the first embodiment of the invention.

FIG. 3 is a diagram showing that in the first embodiment a source address can establish a communication links with multiple destination addresses.

FIG. 4 is a flow chart showing a communication link establishing method according to the second embodiment of the invention.

FIG. 5 is a diagram showing that in the second embodiment multiple source addresses can establish communication links with multiple destination addresses

FIG. 6 is a flow chart showing a communication link establishing method according to the third embodiment of the invention.

FIG. 7 is a diagram showing that in the third embodiment a source address can establish communication links with multiple destination addresses.

FIG. 8 is a flow chart showing a communication link establishing method according to the fourth embodiment of the invention.

FIG. 9 is a diagram showing that in the fourth embodiment multiple source addresses can establish communication links with multiple destination addresses.

### DETAILED DESCRIPTION OF THE EMBODIMENTS

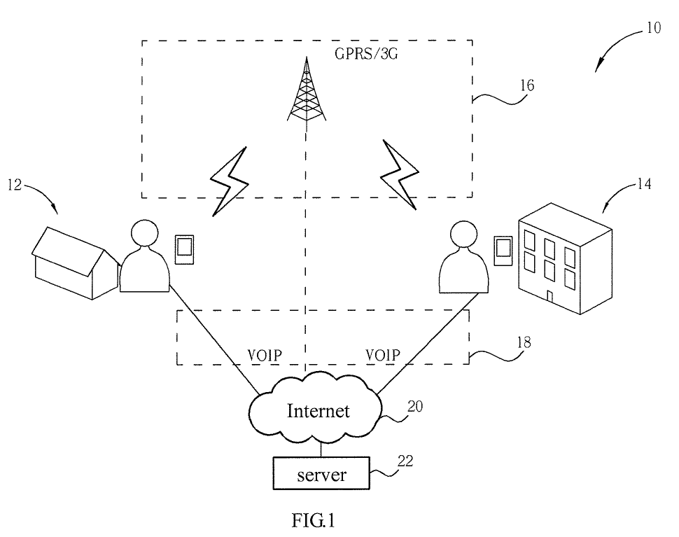

With development of communication technology and communication systems, generally speaking, when users want to establish a communication link, multiple connecting ways are provided to them to be selected. Please refer to FIG. 1. FIG. 1 is a diagram showing a communication network 10 according to one embodiment of the invention. The communication network 10 includes a source device 12, a destination device 14, multiple communication systems 16, a VoIP communication system 18, Internet 20, and a server 22. FIG. 1 shows that if the source device 12 is to be connected to the destination device 14,the source device 12 having a source address, and the destination device 14 having a destination address. Multiple communication link establishing methods are provided, such as making a VoIP call by the Internet 20 to establish a communication link, or with help of the communication systems 16 show in FIG. 1, such as GPRS or 3G, to establish a communication link. FIG. 1 also shows that both the destination device 14 and the source device 12 can be connected to the server 22 to transfer data by the Internet 20.

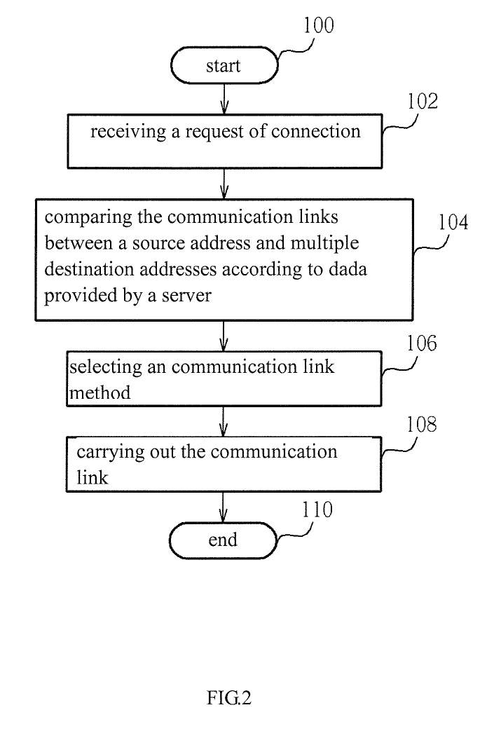

Please refer to FIG. 2 which is a flow chart showing that a communication link establishing method according to the first embodiment of the invention. The communication link establishing method includes the following steps:

Step 100: start;

Step 102: the communication device receiving a request of connection;

Step 104: comparing the communication links between a source address and multiple destination addresses according to dada provided by a server;

Step 106: selecting a communication link method;

Step 108: carrying out the communication link;

Step 110: end.

FIG. 2 is described in detail. In the embodiment of FIG. 2, it is assumed that the first user only includes a source address and destination address (the source address is provided by the source device 12), and the second user includes multiple communication addresses (the destination addresses is provided by the destination device 14). In Step 102, the request of connection is the data (such as name of the second user) input by the first user when the first user is to establish a communication link with the second user. Under this situation, a communication device (such as a mobile phone, a personal computer, and a PDA) of the first user will select a communication link according to the data provided by the server. The data are unit prices of the communication links between the communication system including the source device 12 with source address and the communication destination system including the multiple destination device 14 with destination address, or other comparable data. The data is updated regularly, or when the communication device requests the server for data updating actively, the server will provide updated data and establish the communication link according to the priority ordered by the user such as selecting a communication link method of the cheapest unit price, or other judge criterions ordered by the user and stored in the communication device.

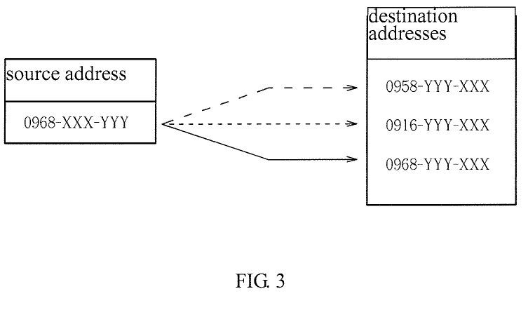

Please refer to FIG. 3 which is a diagram showing that a source address can establish a communication links with multiple destination addresses in the first embodiment. The source address shown in FIG. 3 is 0968-xxx-yyy, and there are three destination addresses which are 0958-yyy-xxx, 0916-yyy-xxx, and 0968-yyy-xxx respectively. According to the data provided by the server, when establishing a communication link between the source address 0968-xxx-yyy and the destination address 0958-yyy-xxx, talking unit price is 5.4 RMB/min. When establishing a communication link between the source address 0968-xxx-yyy and the destination address 0916-yyy-xxx, talking unit price is 5.4 RMB/min. When establishing a communication link between the source address 0968-xxx-yyy and the destination address 0968-yyy-xxx, talking unit price is 2.4 RMB/min. If the communication link is selected according to the talking unit price level, then the communication link between the source address 0968-xxx-yyy and the destination address 0968-yyy-xxx is established because of the lowest talking unit price.

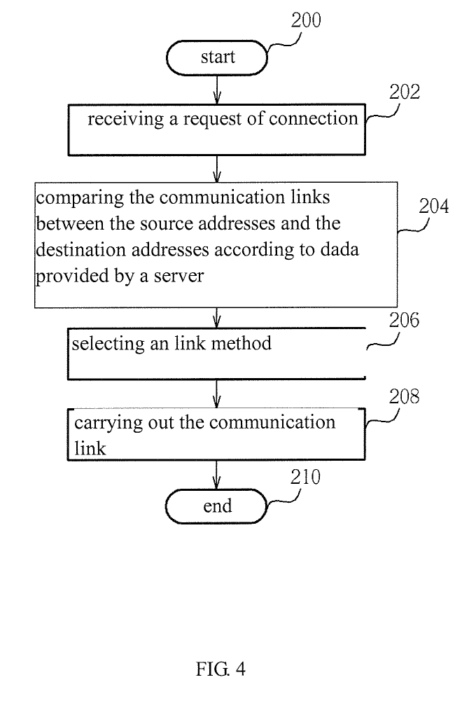

Please refer to FIG. 4 which is a flow chart showing that a communication link establishing method according to the second embodiment of the invention. The communication link establishing method includes the following steps:

Step 200: start;

Step 202: a communication device receiving a request of connection;

Step 204: comparing the communication links between multiple source addresses and multiple destination addresses according to dada provided by a server;

Step 206: selecting a communication link method;

Step 208: carrying out the communication link;

Step 210: end.

FIG. 4 is described in detail. In the embodiment of FIG. 4, it is assumed that the first user includes multiple communication addresses (that are the source addresses), and the second user includes multiple communication addresses (that are the destination addresses).

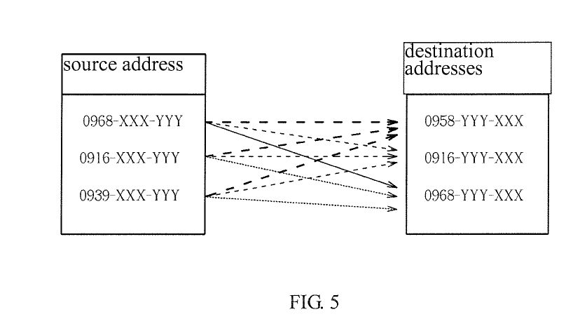

Please refer to FIG. 5 which is a diagram showing that in the second embodiment multiple source addresses can establish communication links with multiple destination addresses. The source addresses shown in the FIG. 5 are 0968-xxx-yyy, 0916-xxx-yyy, and 0939-xxx-yyy, and the destination addresses are 0958-yyy-xxx, 0916-yyy-xxx, and 0968-yyy-xxx respectively. According to the data provided by the server, when establishing a communication link between the source address 0968-xxx-yyy and the destination address 0958-yyy-xxx, talking unit price is 5.4 RMB/min. When establishing a communication link between the source address 0968-xxx-yyy and the destination address 0916-yyy-xxx, talking unit price is 5.4 RMB/min. When establishing a communication link between the source address 0968-xxx-yyy and the destination address 0968-yyy-xxx, talking unit price is 2.4 RMB/min. When establishing a communication link between the source address 0916-xxx-yyy and the destination address 0958-yyy-xxx, talking unit price is 5.7 RMB/min. When establishing a communication link between the source address 0916-xxx-yyy and the destination address 0916-yyy-xxx, talking unit price is 3.0 RMB/min. When establishing a communication link between the source address 0916-xxx-yyy and the destination address 0968-yyy-xxx, talking unit price is 5.7 RMB/min. When establishing a communication link between the source address 0939-xxx-yyy and the destination address 0958-yyy-xxx, talking unit price is 5.5 RMB/min. When establishing a communication link between the source address 0939-xxx-yyy and the destination address 0916-yyy-xxx, talking unit price is 5.5 RMB/min. When establishing a communication link between the source address 0939-xxx-yyy and the destination address 0968-yyy-xxx, talking unit price is 5.5 RMB/min. If the communication link is selected according to the talking unit price level, then the communication link between the source address 0968-xxx-yyy and the destination address 0968-yyy-xxx is established because of the lowest talking unit price.

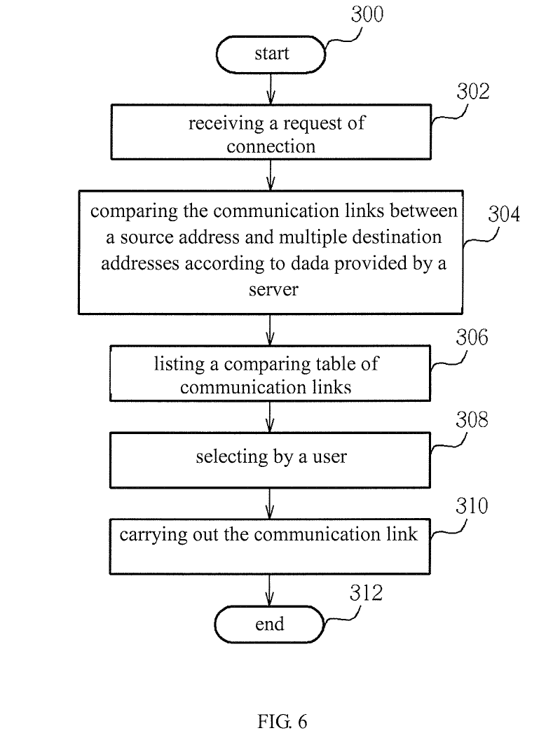

Please refer to FIG. 6 which is a flow chart showing that a communication link establishing method according to the third embodiment of the invention. The communication link establishing method includes the following steps:

Step 300: start;

Step 302: a communication device receiving a request of connection;

Step 304: comparing the communication links between a source address and multiple destination addresses according to dada provided by a server;

Step 306: listing a comparing table of communication links between the source address and the destination addresses;

Step 308: selecting by a user;

Step 310: carrying out the communication link;

Step 312: end.

FIG. 6 is described in detail. In the embodiment of FIG. 6, it is assumed that the first user only includes a communication address (that is the source address), and the second user includes multiple communication addresses (that are the destination addresses). In Step 302, the communication request of connection is the data (such as name of the second user, which is clicked by the first user) input by the first user when the first user is to establish a communication link with the second user. Under this situation, a communication device (such as a mobile phone, a personal computer, and a PDA) of the first user will select a communication link according to the data provided by the server. The data can be unit prices of the communication links between the communication source system including the source address and the communication destination system including the multiple destination addresses, or other related data. The data are updated regularly, or when the communication device requests the server for data updating actively, the server will provide updated data and establish the communication link according to the priority ordered by the user by listing the comparing table of the communication links between the source address and the destination addresses such as a comparing table of unit prices of the communication links, or other judge criterions ordered by the user and stored in the communication device, for comparing the communication link to be selected by users.

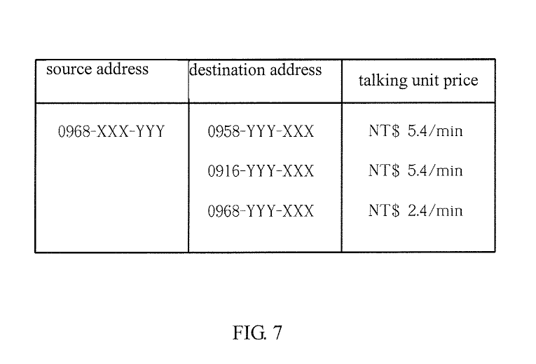

Please refer to FIG. 7 which is a diagram showing that in the third embodiment a source address can establish communication links with multiple destination addresses. As shown in FIG. 7, the source address is 0968-xxx-yyy, and there are three the destination addresses which are 0958-yyy-xxx, 0916-yyy-xxx, and 0968-yyy-xxx respectively. According to the data provided by the server, when establishing a communication link between the source address 0968-xxx-yyy and the destination address 0958-yyy-xxx, talking unit price is 5.4 RMB/min. When establishing a communication link between the source address 0968-xxx-yyy and the destination address 0916-yyy-xxx, talking unit price is 5.4 RMB/min. When establishing a communication link between the source address 0968-xxx-yyy and the destination address 0968-yyy-xxx, talking unit price is 2.4 RMB/min. If the user defines that the communication links are shown in a table according to the talking unit price level, the results are shown as the talking unit price character shown in FIG. 7. The user carries out a communication link according to comparison of the results.

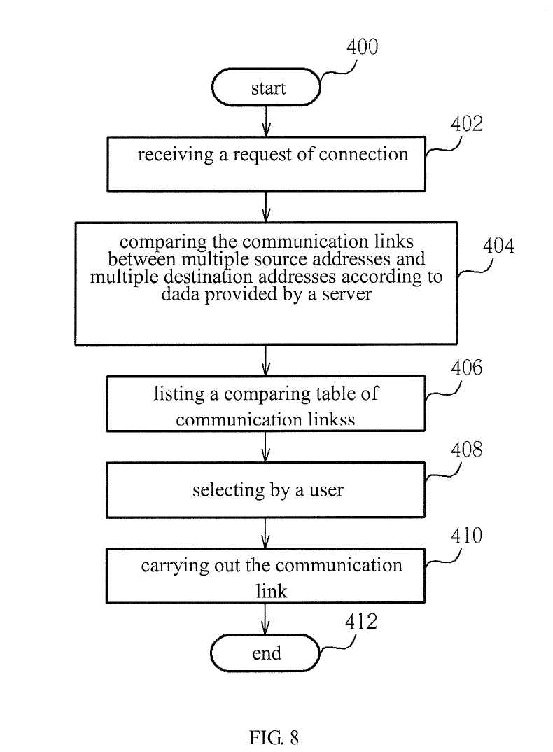

Please refer to FIG. 8 which is a flow chart showing that a communication link establishing method according to the fourth embodiment of the invention. The communication link establishing method includes the following steps:

Step 400: start;

Step 402: a communication device receiving a request of connection;

Step 404: comparing the communication links between multiple source addresses and multiple destination addresses according to dada provided by a server;

Step 406: listing a comparing table of communication links between the source addresses and the destination addresses;

Step 408: selecting a communication link establishing method by a user;

Step 410: carrying out the communication link;

Step 412: end.

FIG. 8 is described in detail. In the embodiment of FIG. 8, it is assumed that the first user includes multiple communication addresses (that are the source addresses), and the second user includes multiple communication addresses (that are the destination addresses).

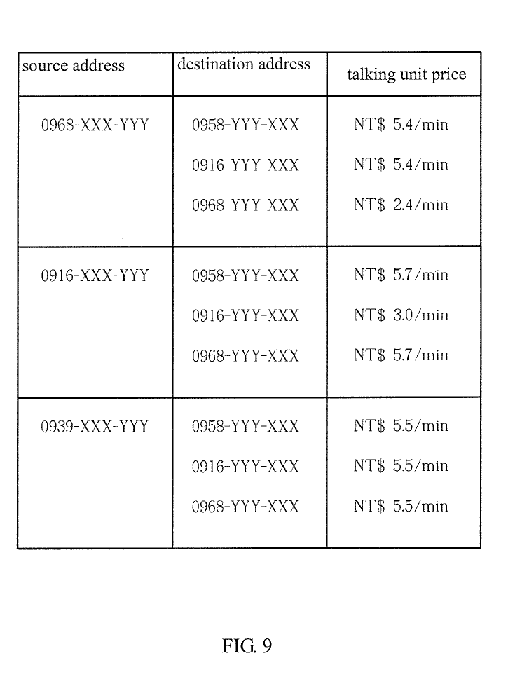

FIG. 9 is a diagram showing in the fourth embodiment multiple source addresses can establish communication links with multiple destination addresses. The source addresses shown in the FIG. 9 are 0968-xxx-yyy, 0916-xxx-yyy, and 0939-xxx-yyy, and the destination addresses are 0958-yyy-xxx, 0916-yyy-xxx, and 0968-yyy-xxx respectively. According to the data provided by the server, when establishing a communication link between the source address 0968-xxx-yyy and the destination address 0958-yyy-xxx, talking unit price is 5.4 RMB/min. When establishing a communication link between the source address 0968-xxx-yyy and the destination address 0916-yyy-xxx, talking unit price is 5.4 RMB/min. When establishing a communication link between the source address 0968-xxx-yyy and the destination address 0968-yyy-xxx, talking unit price is 2.4 RMB/min. When establishing a communication link between the source address 0916-xxx-yyy and the destination address 0958-yyy-xxx, talking unit price is 5.7 RMB/min. When establishing a communication link between the source address 0916-xxx-yyy and the destination address 0916-yyy-xxx, talking unit price is 3.0 RMB/min. When establishing a communication link between the source address 0916-xxx-yyy and the destination address 0968-yyy-xxx, talking unit price is 5.7 RMB/min. When establishing a communication link between the source address 0939-xxx-yyy and the destination address 0958-yyy-xxx, talking unit price is 5.5 RMB/min. When establishing a communication link between the source address 0939-xxx-yyy and the destination address 0916-yyy-xxx, talking unit price is 5.5 RMB/min. When establishing a communication link between the source address 0939-xxx-yyy and the destination address 0968-yyy-xxx, talking unit price is 5.5 RMB/min. If the user defines that the communication links are shown in a table according to the talking unit price level, the results are shown as the talking unit price character shown in FIG. 9. The user carries out a communication link according to comparison of the results.

The communication link established according to the embodiment of the invention is not only between mobile phones and telephones, but also between web phones. For example, the first user includes a skype number (a source address), and the second user includes a mobile phone number and a skype number (two destination address). When the first user is to establish a communication link with the second user, the invention can provide first user a comparing table of unit prices of the skype number calling the mobile phone number and the skype number of the second user, which makes it convenient for the first user to select a communication link.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A communication link establishing method, comprising the steps of:
comparing, by a communication device, commutation links between at least a source address and at least a destination address according to data provided to the communication device by a server when the communication device receiving a request of connection;
selecting an appropriate destination address according to comparing result of the commutation links between the source address and the destination address; and
establishing the communication link according to the appropriate destination address.

2. The method according to claim 1, wherein the data provided to the communication device by the server is that regularly updated and transferred to the communication device by the sever.

3. The method according to claim 1, wherein the data provided to the communication device by the server are unit price data updated and transferred to the communication device by the sever.

4. The method according to claim 1, wherein comparing the commutation links between the source address and the destination address is comparing talking unit prices between the source address and the destination address.

5. The method according to claim 1, wherein selecting the appropriate destination address according to the comparing result of the commutation links between the source address and the destination address is selecting the way of the cheapest communication unit price to establish the communication link with the appropriate destination address or establishing the communication link with the appropriate destination address according to a judge criterion stored in the communication device.

6. A communication link establishing method, comprising the steps of:
comparing, by a communication device, commutation links between at least a source address and at least a destination address according to data provided to the communication device by a server when the communication device receiving a request of connection;
displaying at least a comparing table of the commutation links according to comparison of the commutation links between the source address and the destination address;
selecting an appropriate destination address according to the comparing table; and
establishing the communication link according to the appropriate destination address.

7. The method according to claim 6, wherein the data provided to the communication device by the server is that regularly updated and transferred to the communication device by the sever.

8. The method according to claim 6, wherein the data provided to the communication device by the server are unit price data updated and transferred to the communication device by the sever.

9. The method according to claim 6, further comprising the step of requesting, by the communication device, the server to update the data transferred to the communication device.

10. The method according to claim 6, wherein the comparing table of the communication links includes the source address, the destination address, and a corresponding talking unit price.

11. The method according to claim 6, wherein selecting the appropriate destination address according to the comparing table is selecting the way of cheapest communication unit price to establish the communication link with the appropriate destination address or establishing the communication link with the appropriate destination address according to a judge criterion stored in the communication device.
